(19) United States
(12) Patent Application Publication
(10) Pub. No.: US 2021/0012440 A1
(43) Pub. Date: Jan. 14, 2021

(54) PROPERTY VALUATION USING CROWDSOURCING AND REWARDS

(71) Applicant: International Business Machines Corporation, Armonk, NY (US)

(72) Inventors: Felix Bonard Kwizera, Riruta Satelite (KE); Violette Ogega, Nairobi (KE); Isaac Waweru Wambugu, Markham (CA); Shikhar Kwatra, Durham, NC (US); Komminist Weldemariam, Ottawa (CA)

(21) Appl. No.: 16/504,472

(22) Filed: Jul. 8, 2019

(51) Int. Cl. G06Q 50/16; G06Q 50/00; G06F 9/54

(52) U.S. Cl. CPC G06Q 50/163; G06F 9/542; G06Q 50/01

(57) ABSTRACT

A property valuation method, system, and computer program product, including determining a set of features required to perform a valuation of a property at a location with a valuation coverage area, broadcasting the set of features to crowdsourced devices within the valuation coverage area, and determining a property valuation score for the location based on a received set of features from at least one of the crowdsourced devices.

### BACKGROUND

The present invention relates generally to a property valuation method, and more particularly, but not by way of limitation, to a system, method, and computer program product for property valuation using crowdsourcing and rewards.

Property valuation includes the process of developing an opinion of value for real property (usually market value). Conventionally, there are two kinds of property valuation. First, valuing property for a government property tax purpose and, secondly, valuing property for a mortgage purpose.

In both cases, conventionally, there are a number of ways employed for property valuation that usually involve a number of processes, documents, and stakeholders (e.g., government entities, banks, private entities, etc.).

Governments across developing countries are losing billions of dollars due to tax avoidance caused by under-valued property taxes. Zone value determination in the unstructured (or informal) settlement is a challenge and a source of fraud. This is because it is so difficult to correctly and transparently value a property. Traditional land valuation methods such as the use of expert surveyors who physically collect data about the zone (e.g., expenses incurred in acquiring the land, comparable sales, location of the property, availability of services and facilities, distance from the water bodies, etc.) can also be another source of fraud and incorrect valuation of a piece of land.

In the developed world, there is a clear distinction between the different kinds of properties such as residential, commercial, industrial, etc. A general rule for the practical or real tenure of different kinds of properties for valuation may be slightly straightforward.

Some conventional valuation methods include using properties extracted from bordering specified geographic features, aerial imagery-based techniques, user activity-based techniques, by aggregating user activities associated with a real estate website, etc.

However, in most developing countries a property valuation and validation continue to remain an open problem due to the complexity of the processes, lack of transparency and multiple-level colluding or corruption.

The process of creating a property valuation data value stream is very complex. This process would require data collection where valuation data are gathered through a labor-intensive human network of site inspection (and the use of a drone or aerial images just started but the approach is suffering from a poor quality of image data due to the informal or unstructured settlement structure), verification where manual site inspection process that attempts to establish corroborating sources, and analysis or interpretation where experts base an evaluation of information available using manual processes.

Another challenge is that evolving characteristics and context of a neighborhood with unstructured zoning poses great challenges for the collection, aggregation, validation, and overall reactivity to a neighborhood index.

And, another challenge in the conventional techniques is that the ganularity of traditionally used attributes/features for property valuation in developing countries is not adequate.

### SUMMARY

Based on the above challenges and drawbacks in the conventional techniques, the inventors have recognized that there are manual, time consuming, inconsistent and fraud-centric ways to value/validate/verify property valuation in developing countries.

In an exemplary embodiment, the present invention provides a computer-implemented property valuation method, the method including determining a set of features required to perform a valuation of a property at a location with a valuation coverage area, broadcasting the set of features to crowdsourced devices within the valuation coverage area, and determining a property valuation score for the location based on a received set of features from the crowdsourced devices.

One or more other exemplary embodiments include a computer program product and a system, based on the method described above.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a property valuation method 100 according to an embodiment of the present invention;

FIG. 2 exemplarily depicts a process of creating and distributing features for a property valuation/validation using crowdsourced users according to an embodiment of the present invention;

FIG. 3 exemplarily depicts a system architecture for computing and comparing property valuation based on crowdsourced collection and base valuation learning models according to an embodiment of the present invention;

FIG. 4 exemplarily depicts an example of an augmented-reality property valuation according to an embodiment of the present invention;

FIG. 5 depicts a cloud-computing node 10 according to an embodiment of the present invention;

FIG. 6 depicts a cloud-computing environment 50 according to an embodiment of the present invention; and

FIG. 7 depicts abstraction model layers according to an embodiment of the present invention.

### DETAILED DESCRIPTION

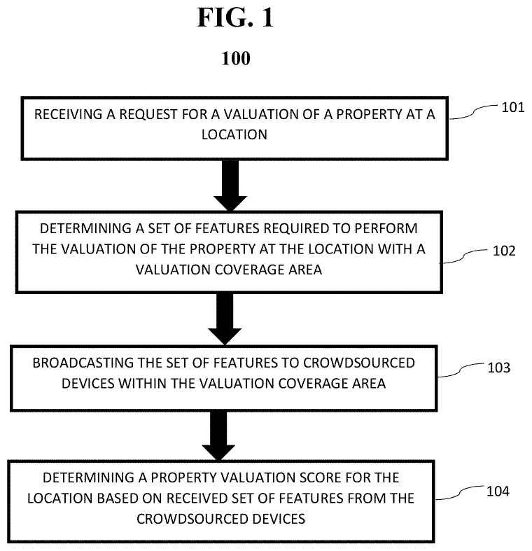

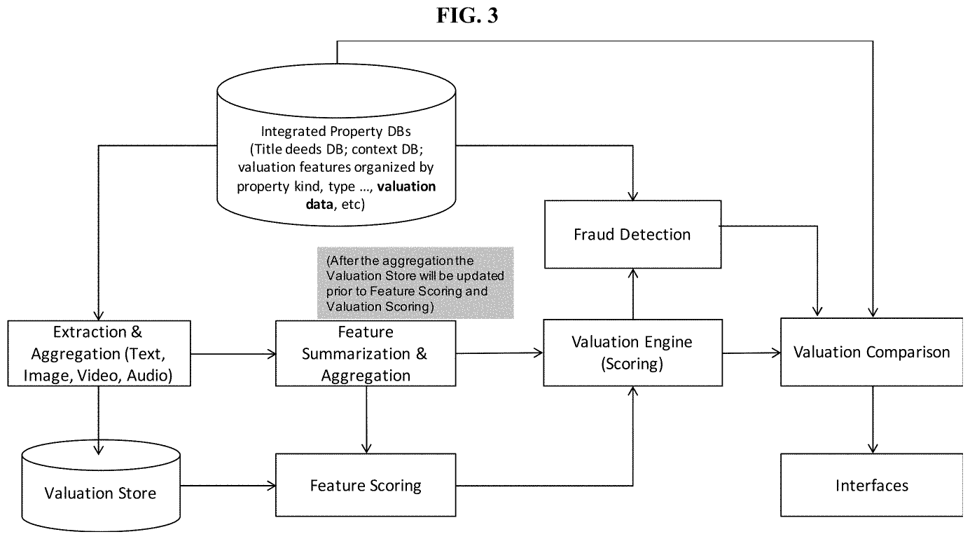

The invention will now be described with reference to FIGS. 1-7, in which like reference numerals refer to like parts throughout. It is emphasized that, according to common practice, the various features of the drawings are not necessarily to scale. On the contrary, the dimensions of the various features can be arbitrarily expanded or reduced for clarity.

By way of introduction of the example depicted in FIG. 1, an embodiment of a property valuation method 100 according to the present invention can include various steps for determining a property valuation score(s) for a location based on received valuation assessments from the crowdsourced users and/or devices.

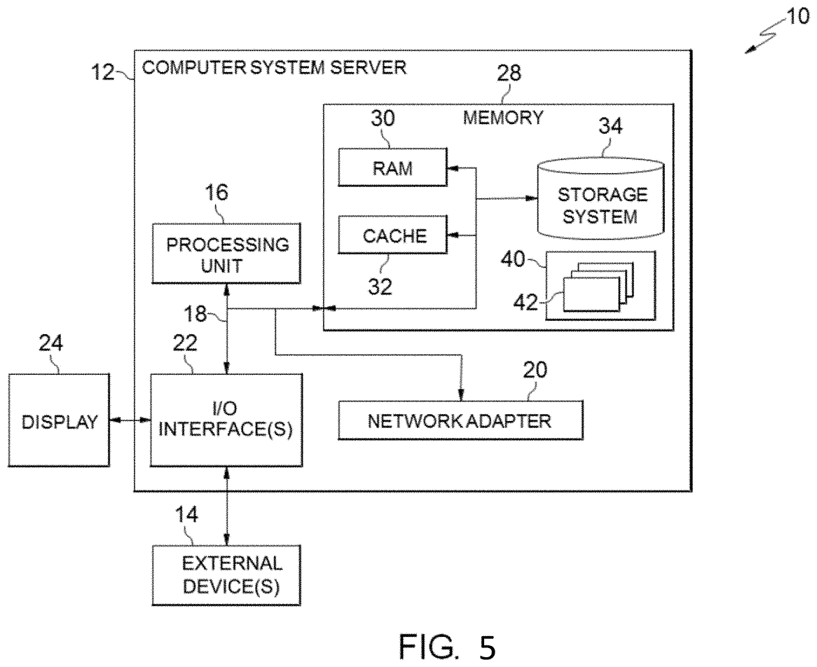

By way of introduction of the example depicted in FIG. 5, one or more computers of a computer system 12 according to an embodiment of the present invention can include a memory 28 having instructions stored in a storage system to perform the steps of FIG. 1.

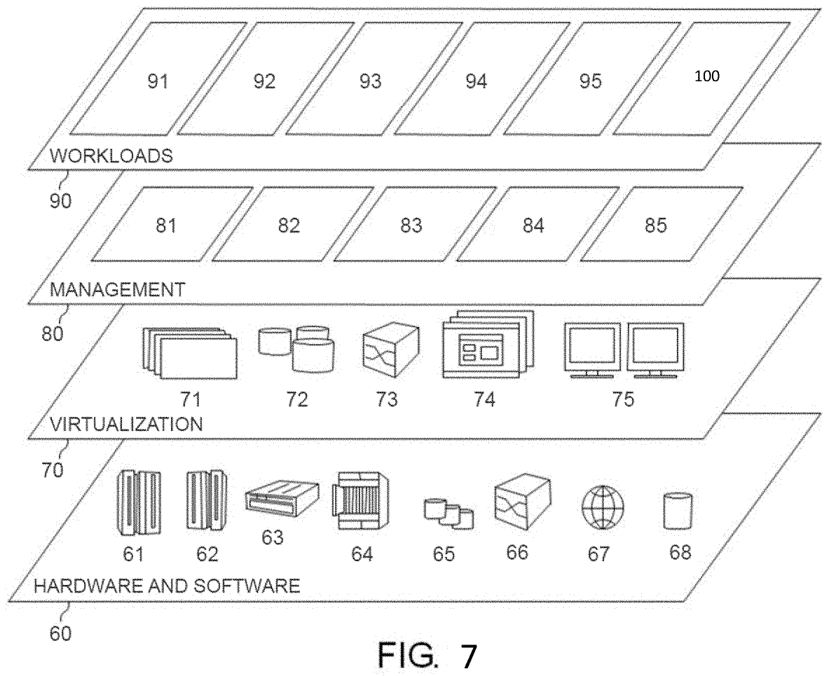

Although one or more embodiments may be implemented in a cloud environment 50 (e.g., FIG. 7), it is nonetheless understood that the present invention can be implemented outside of the cloud environment.

With reference to FIGS. 1-3, in step 101, a need for valuing (and/or validating valuation of) a property at a location L is received. In step 102, a set of attributes/features needed to valuate a property at the location L with valuation coverage area A is determined.

In step 103, the set of attributes/features are broadcasted to users and/or devices within the area of coverage A. And, in step 104, a property valuation score(s) is determined for the location L based on received valuation assessments from the crowdsourced users and/or devices.

In one embodiment, the determining attributes/features of a property is based on a number of factors such as the kind and/or type of the property (e.g., residential, commercial, industrial, etc.) in context, past history of the property (e.g., dispute case, etc.), past history of users (e.g., the owner, valuator, etc.), weights of individual features toward the final value or score, etc.

In another embodiment, the feature selection further generates different valuation modalities for a property attribute/feature to reduce a possible or predicted bias during the valuing process. For example, for a property P (at a given location L) and a feature F₁ (i.e., “proximity to amendments”), user U₁ may be asked to rank/score (from 1 to 10), whereas User U₈ may be asked to provide the number of amendments within 1 km.

In one embodiment, the collecting of a property valuing/validation is based on instantly formed crowdsourced users where the formation of the instant crowdsourced users is based on a number of factors such as past history of valuation contribution, reputation/credibility of a user, a user profile, etc.

In another embodiment, the valuation of a property may be dynamically updated through aerial analysis of surrounding physical features and man-made structures over time as well as information on ground rock formation and hydrological features.

In one embodiment, bias of an assessment is detected using machine learning models (e.g., subset scanning methods) where assessments are reweighed to conform to mitigate the detected bias.

In one embodiment, crowdsourced property valuators or assessors are rewarded for their participation in valuating, validating or scoring property feature/value.

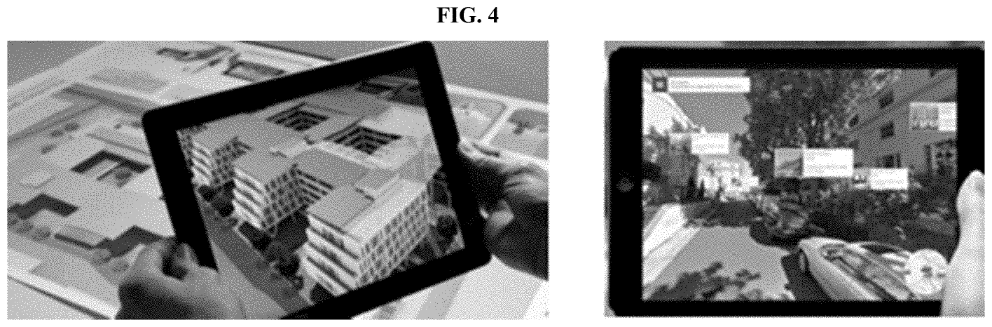

In another embodiment, via a blueprint of a scanned plot or via an actual presentation of a plot at a particular area through an augmented reality (AR)/virtual reality (VR) interface, the user can be given the priority list of property with reasons for a computed valuation such as shown in FIG. 4.

With reference generally to FIGS. 1-3, the invention includes a technique to compute a valuation of a property in a given location L based on crowdsourced users and/or devices, by determining a set of attributes/features needed to evaluate a property at a location L with valuation coverage area A, broadcasting the set of attributes/features to users and/or devices within the area of coverage A, and then determining a property valuation score(s) for the location L based on received valuation assessments from the crowdsourced users and/or devices. Such property valuation can be highlighted in an AR/VR environment when the user scans area/texture map and can show a priority of property valuations (e.g., in the vicinity) based on variational validation scores ranking with the reasoning for valuations for enhanced user convenience.

In one embodiment, receiving the need for valuing and/or validating valuation of a property at a given location L may be related to determining a government property tax, a mortgage amount, a dispute resolution, etc. The technique of receiving valuation request may be triggered by for example, SMS, a phone call, a website, by scanning a unique code of property, etc.

The property valuation/validation process includes at least three parts: (i) methods, systems and apparatus for acquiring fine-granular property assessments by using crowdsourcing users and devices; (ii) methods and systems for determining or estimating a final property score/value; and (iii) a method for determining rewards for crowd participation in evaluating or validating property value.

In the first part (i), the invention may determine the context of valuation/validation from the request payload and other data sources. The processing of the context information is used to determine the attributes/features of a property to be assessed by crowdsourced users and devices.

The invention may use a feature selection and grouping method (such as univariate selection, feature importance and/or correlation matrix with heatmap) to further determine the possible number of attributes/features (e.g., F={F₁,F₂, . . . , F_{N}}) for a property validation or valuation based on a number of factors such as the kind and/or type of the property (residential, commercial, industrial, etc.) in context, past history of the property (e.g., dispute case), past history of users (e.g., the owner, value, etc.), weights of individual features toward the final value or score, etc. Using “F”, the splitting feature engine generates “M” number of groups (G={G₁={F₁, . . . , F_{W}}, G₂={F₃,F₉}, . . . , G_{M}={F₅,F₇, . . . , F_{T}}}, where Gᵢ contains one or more features from F) that are not necessarily disjoint sets.

Periodically, a bias detection process is running on the model to ensure that the model consistently selects similar features that professional land surveyors would. The bias detection evaluates the model's selected features and those normally selected by land surveyors and compares the disparities of the two—if they are too disproportional, a warning may either be triggered, or the model may be retrained with its training data reweighed to prioritize some of the features that were not selected. The re-trained model is then deployed and used to perform a new feature selection,

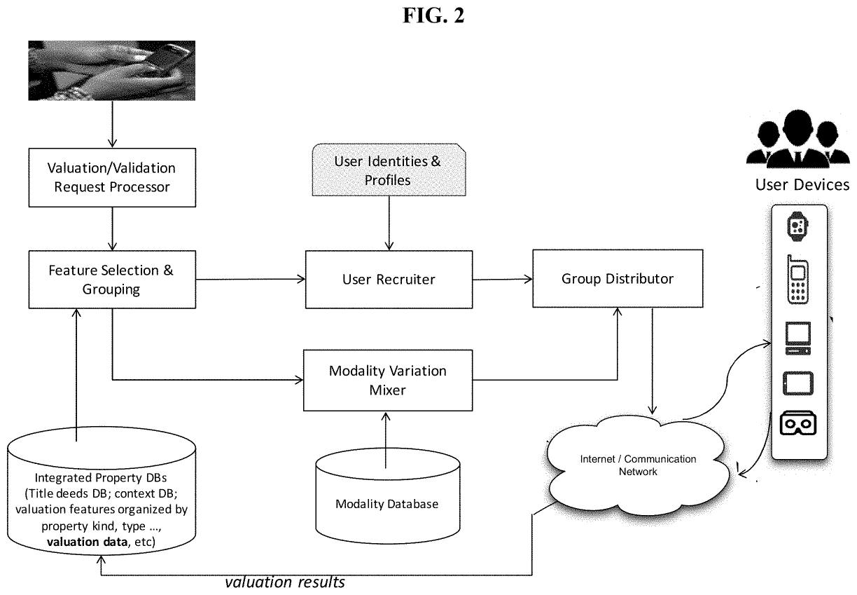

In FIG. 2, the User Recruiter module takes the valuation/validation context and attribute/feature set F to determine the quality and number of users to be invited for valuating features of the property at a given location L. More specifically, users are selected (e.g., “K” number of users, where K≥M and K and M are integers and greater than zero) to collect or valuate selected features (e.g., a user in the crowd maybe asked to evaluate features of group Gᵢ). Note that the crowd selector module may use pre-registered user profile database or leverage telecommunications network providers. The M number of features' groups are distributed to K number of crowdsourced users U at different time intervals.

In some sense, the technique of distributing each Gᵢ to selected users may be take into consideration each user profile. The user profile may contain experience level of the user in data collection, education level, etc. which can be extracted from the user social media data.

The technique of selecting attribute/feature can be self-configured based on the types of the property or based on a user-defined rules specification (e.g., location, context, legislation, culture of the location, specific zonal configuration, etc.). A graphical user interface (GUI) and other interfaces may be used to specify/upload the rules. These rules can be learned based on a plurality of other data sources such as real-state websites, social network sites, news feeds, data generated from user computing/communication devices (e.g., phone roaming, etc.), drive-by vehicles, satellite images, etc.

In one embodiment, the valuation data (including historical valuation transactions and metadata), details of each property being valuated with their associated metadata, any other transaction against the property, user profile models, bias models, and so on may be stored on Blockchains as the core building block for a digital housing ecosystem where banks, mortgage lenders, home owners, buyers, insurance companies, contractors, lawyers, title companies, etc. are all participants. Interactions amongst ecosystem participants are modelled as transactions on the blockchain system.

The invention derives the pattern history sequencing and endorsing peers in the Blockchain network using a long short-term memory (LSTM) model for deriving the valuation assessment score by evaluating the authenticity of users involved in the feature valuation.

The request to participate in crowdsourced valuation may be based on a certain event and context. For example, a submission of valuations for all features of G₁ by a user U₁ may trigger the distributor engine to send one or more features' groups to users.

The distributor engine can be refined by determining the scoring of the endorsing peers or users involved in the valuation over training period “T”, thereby building the credibility rate of users. This means an indirect correlation is established between the endorsing peers and the success or rating/valuating given properties in the past by determining the difference between an actual value and the predicted valuation. Higher credibility is inversely proportional to the difference in the actual and predicted valuations.

In one embodiment, the receiving of a valuation of a feature may be shown on a user device as a notification, beep-sounds or personalized ringtone, or various visual indicators (e.g. change color, vibrating user device on a particular way, etc.).

The feature selection module for distribution to crowdsourced users may further determine different valuation modalities for a single feature so that for a feature F different values can be collected by different users. This may reduce possible biasing during the valuation process. For example, for a property P (at a given location L) and a feature F₁ (e.g., “proximity to amendments”), User U₁ may be asked to rank/score (from 1 to 10), whereas User U8 may be asked to provide the number of amendments within 1 km.

In another embodiment, the technique of determining the property valuation scores further includes detecting if any of the assessments) containing any bias require a reweighing of the data to conform to industry standard practices. Variant(s) of statistic and subset scanning methods coupled with gaussian processes can be used for detecting valuation bias.

In the second part (ii), the techniques of determining or estimating a final property score/value may include extraction and aggregation of data (of type: text, image, video, audio, etc.) received from crowdsourced users and devices, feature summarization and aggregation, feature scoring, valuation scoring, and compassing of scores for final decision making.

For each feature, the technique of property valuation determination further extracts and analyzes data collected (text, image, video, etc.) using natural language process NLP), image analytics, deep-learning, etc. and aggregates the analysis results into valuation stores suitable for feature summarization and aggregation.

In one embodiment, machine learning models are trained using a plurality of valuation data, and context data. These models are used for anomaly and fraud detection in real-time.

Similarity correlation is conducted between professional land surveyor's data and features selected from the subset F in order to take into account discrete validation metrics.

Pearson correlation executes the similarity analysis based on semantic distance between the feature set. The product-moment correlation coefficient is a measure of the strength of the linear relationship between two features to reconfigure the weights associated with crowdsourced data X and professional surveyor dataset Y:

$${r}_{XY} = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}}$$

If the correlation coefficient value compute is less than 0, then principal component analysis is performed for feature pruning on the feature set and extracting of the relevant parameters to be taken into account for enhanced validation which is an indirect correlation of reduced credibility (or fraud detection).

If the Pearson correlation pertaining to the user's feature set is greater than 0, then a reward function of (+1) is provided at each time step along the process of the property validation, otherwise if −1<PCC<0, a reward function of −1 is allocated to the user as part of DeepRL network.

In another embodiment, either via blueprint of the scanned plot or via actual presentation of the plot at a particular area through Google Glass™/AR interface, the user can be given the priority list of property with explanation for a computed valuation.

In another embodiment, the technique is integrated into a central database of title deeds or blockchain based title deeds database, once the valuation is completed, the report is attached to the title deed such that a record of a property's value exists in an immutable fashion to combat fraud and undervaluation (i.e., if a property's value suddenly dips without any reason, it's previous valuations can be used such an anomaly). The property's value can also be used for mortgage purposes.

In another embodiment, a specialized search engine maybe embedded with the valuation database for a trusted digital real estate marketplace to enable a digitally valuated and traced housing ecosystem. The digital real estate marketplace maybe configured with a cognitive chatbot and Google Glass/AR interface to provide effective digital experience.

In another embodiment, the technique of automatically valuating or validating using crowdsourced users can be used a service in an opt-in basis. For example, Ministry of Land, general public (e.g., property buyers and sellers, etc.), banks, legal departments, etc. can request the service by supplying specific context, events, etc.

For bias detection on land valuation, many factors affect the value of the land. Some causes may cause the land to appreciate and others may lead to depreciation. For instance, a quarry industry may make the land appreciate in a short term and after the quarry is abandoned, it may cause the land to depreciate exponentially. However, without working with a system that does not put all of these factors into context, automated land valuation may be inefficient. To address this, in one embodiment, the invention may run a bias detection algorithm that filters or incorporates outliers in the inputs.

After land valuation, the invention assumes that there are two valuation sets. One valuation set is the actual amount for a property in context to which people are transacting on the ground, and the second valuation set is the published land valuation amount as generated by the land valuation system that is proposed herein. In one embodiment, the invention runs a bias detection model to identify if there are any discrepancies between the two valuations.

To curb this, the invention would first identify and analyze the valuation error of the land valuation amount. Second would be to detect distortions in the prices generated and published prices. The system proposes a method of identifying the type of bias and strategies to mitigate that bias.

Three potential types of bias that can be countered are:

“Hypothetical Bias”—This occurs due to misrepresentation of the value due to individuals responding to hypothetical scenarios differently than they should in the same scenarios in the real world. For instance, a proposed government intervention may be overhyped and raise the prices in a region based on a hypothetical impact of that intervention. Yet in the real world and based on previous interventions of that kind, the impact may not be that good (i.e., not that economically favorable). In this case, the mitigation measure would be to conduct a contingency-valuation survey using an expert system.

“Anchoring bias”—This bias is set when one sets a very high initial price thus making other individuals set high prices too and thus forms a precedence to the subsequent land valuers. It is also known as the “starting point bias”. The only mitigation is pretested survey design. This requires a human in the loop kind of system to avert this bias.

“Shift bias”—This bias involves repeated bids on the already anchored price. This propagates the wrong price and thus the published prices will always be lower than the fair market value. Mitigating this type of bias is based on supply and demand. All the system can provide is to indicate the overvaluation or the undervaluation and hope the market will correct it.

Thereby, the invention can provide appropriate valuation scores for properties even in undeveloped areas. Instead of static values based on location as in conventional methods, the invention provides a dynamic approach system/model which can be retrained based on many feature attributes. Further, bias can be mitigated (or eliminated).

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 5, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as-an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

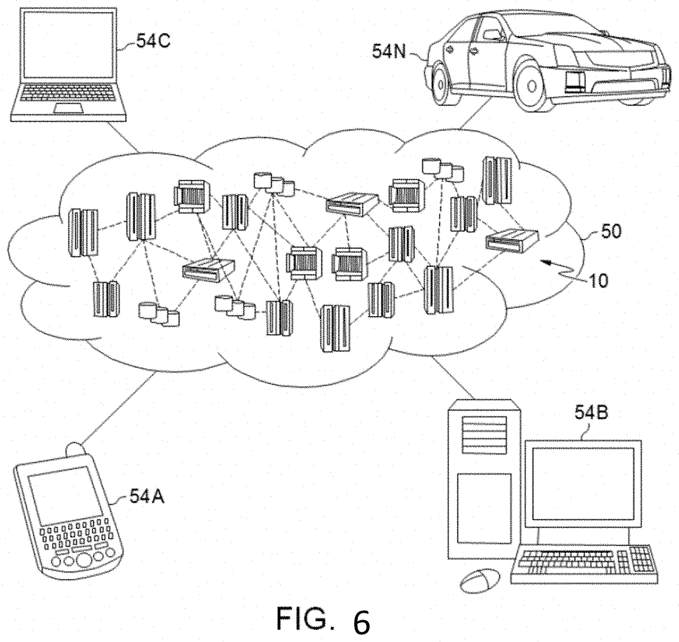

Referring now to FIG. 6, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another, They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 6 are intended to be illustrative only and that computing nodes 10 and cloud computing environment 50 can communicate with any type of computerized circuit over any type of network and/or network addressable connection (e.g., using a web browser).

Referring now to FIG. 7, an exemplary set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and property valuation method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM) a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the. Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent i.s to encompass the equivalents of all claim elements, and no amendment to any claim of the present application should be construed as a disclaimer of any interest in or right to an equivalent of any element or feature of the amended claim.

What is claimed is:

1. A computer-implemented property valuation method, the method comprising:
determining a set of features required to perform a valuation of a property at a location with a valuation coverage area;
broadcasting the set of features to crowdsourced devices within the valuation coverage area; and
determining a property valuation score for the location based on a received set of features from at least one of the crowdsourced devices.

2. The method of claim 1, wherein the set of features of the property is based on at least one of:
a type of the property;
a past history of the property;
a past history of an owner of a device of the devices; and
a weight of a feature of the set of features toward the property valuation score.

3. The method of claim 1, further comprising generating different valuation modalities for the property to reduce a bias during the determining the property valuation score.

4. The method of claim 1, wherein a selection of the crowdsourced devices is based on at least one of:
a past history of a valuation contribution;
a reputation of an owner of the device; and
a profile of the owner of the device.

5. The method of claim 1, further comprising dynamically updating the valuation of the property through at least one of:
aerial analysis of surrounding physical features and man-made structures over time;
information on ground rock formation of the location; and
a hydrological feature of the location.

6. The method of claim 1, further comprising detecting a bias by an owner of one of the crowdsourced devices in the valuation of the property.

7. The method of claim 6, further comprising determining an adjusted property valuation score that re-computes the property valuation score to mitigate the bias by the owner of one of the crowdsources devices.

8. The method of claim 1, further comprising enabling a digital housing ecosystem where banks, mortgage lenders, home owners, buyers, insurance companies, contractors, lawyers, and title companies are all participants.

9. The method of claim 1, further comprising embedding a specialized search engine in the digital housing ecosystem to enable a real estate marketplace.

10. The method of claim 1, wherein the crowdsourced devices include an augmented reality feature, and
wherein an owner of on of the crowdsourced devices uses the augmented reality feature to provide an explanation for the valuation given.
configuring with a cognitive chatbot to provide effective digital experience.

11. A computer program product for property valuation, the computer program product comprising a computer-readable storage medium having program instructions embodied therewith, the program instructions executable by a computer to cause the computer to perform:
determining a set of features required to perform a valuation of a property at a location with a valuation coverage area;
broadcasting the set of features to crowdsourced devices within the valuation coverage area; and
determining a property valuation score for the location based on a received set of features from at least one of the crowdsourced devices.

12. The computer program product of claim 11, wherein the set of features of the property is based on at least one of:
a type of the property;
a past history of the property;
a past history of an owner of a device of the devices; and
a weight of a feature of the set of features toward the property valuation score.

3. The computer program product of claim 11, further comprising generating different valuation modalities for the property to reduce a bias during the determining the property valuation score.

14. The computer program product of claim 11, wherein a selection of the crowdsourced devices is based on at least one of:
a past history of a valuation contribution;
a reputation of an owner of the device; and
a profile of the owner of the device.

15. The computer program product of claim 11, further comprising dynamically updating the valuation of the property through at least one of:
aerial analysis of surrounding physical features and man-made structures over time;
information on ground rock formation of the location; and
a hydrological feature of the location.

16. The computer program product of claim 11, further comprising detecting a bias by an owner of one of the crowdsourced devices in the valuation of the property.

17. The computer program product of claim 16, further comprising determining an adjusted property valuation score that re-computes the property valuation score to mitigate the bias by the owner of one of the crowdsourced devices.

18. The computer program product of claim 11, wherein the crowdsourced devices include an augmented reality feature, and
wherein an owner of one of the crowdsourced devices uses the augmented reality feature to provide a reason for the valuation given.

19. A property valuation system, the system comprising:
a processor; and
a memory, the memory storing instructions to cause the processor to perform:
determining a set of features required to perform a valuation of a property at a location with a valuation coverage area;
broadcasting the set of features to crowdsourced devices within the valuation coverage area; and
determining a property valuation score for the location based on a received set of features from at least one of the crowdsourced devices.

20. The system of claim 19, further comprising:
detecting a bias by an owner of one of the crowdsourced devices in the valuation of the property; and
determining an adjusted property valuation score that re-computes the property valuation score to mitigate the bias by the owner.
